(19) United States
(12) Patent Application Publication
(10) Pub. No.: US 2005/0001071 A1
(43) Pub. Date: Jan. 6, 2005

(54) Fuel passage sealing structure of fuel injection nozzle

(76) Inventors: Kunihiko Hashimoto, Saitama (JP); Kazutaka Iioka, Saitama (JP); Toshiki Sawaki, Saitama (JP); Sakae Sato, Saitama (JP)

Correspondence Address: OSTROLENK FABER GERB & SOFFEN, 1180 AVENUE OF THE AMERICAS, NEW YORK, NY, 100368403, US

(21) Appl. No.: 10/494,394

(22) PCT Filed: Oct. 31, 2002
(86) PCT No.: PCT/JP02/11340

(30) Foreign Application Priority Data
Nov. 2, 2001 (JP) 2001-338402
Nov. 2, 2001 (JP) 2001-338403

(51) Int. Cl. F02M 59/00; F02M 61/00; B05B 1/30

(52) U.S. Cl. 239/533.2; 239/533.3; 239/585.5

(57) ABSTRACT

An object of the present invention is to provide a fuel path sealing structure for a fuel injection valve that is capable of preventing a high pressure fuel leak by increasing the seal surface pressure between a first body such as an injector housing, and a second body such as a nozzle body to thus permit an increase in the seal surface pressure without a change to the size of the nozzle nut or the corresponding tightening force. The present invention is directed toward the formation, over a predetermined surface area, of slightly shallow micro-recesses, in regions other than the high pressure fuel paths and the periphery of the seal surfaces, that is, at the center of the seal surface. The present invention is characterized in that slightly shallow micro-recesses are formed over a predetermined surface area of at least either one of the first seal surface of the first body and the second seal surface of the second body, avoiding the first fuel path, second fuel path, and the respective periphery of the first body and the second body.

### BACKGROUND OF THE INVENTION

1. Field of the Invention

The present invention relates to a fuel path sealing structure for a fuel injection valve, and more particularly to a fuel path sealing structure for a fuel injection valve that injects, with predetermined timing, high pressure fuel which is supplied via an accumulator (common rail) or the like.

2. Description of the Related Art

A conventional fuel injection valve and the fuel path sealing structure thereof will be outlined in accordance with FIG. 13.

FIG. 13 is a cross-sectional view of the constituent elements of a fuel injection valve 1 which comprises an injector housing 2 (first body), a nozzle body 3 (second body), a nozzle needle 4, and a back pressure control portion 5.

Two or more first location holes 6 are formed in the injector housing 2 and an equal number of second location holes 7 are formed in the nozzle body 3. The injector housing 2 and nozzle body 3 are aligned with one another by means of a locating pin 8 that is pushed into the first location holes 6 and the second location holes 7, and the nozzle body 3 is attached to the tip of the injector housing 2 by means of a nozzle nut 9, the back pressure control portion 5 being provided thereabove.

Fuel from a fuel tank 10 is pressurized to a high pressure by a fuel pump 11 and accumulates in a common rail 12 (accumulator), and high pressure fuel is supplied to the fuel injection valve 1.

In other words, a first fuel path 13 is formed in the injector housing 2 and a second fuel path 14 is formed in the nozzle body 3, and a fuel reservoir 15 is formed facing a pressure receiver 4A of the nozzle needle 4, such that high pressure fuel can be continually supplied to the fuel reservoir 15 from the common rail 12.

Furthermore, a fuel return line 16 is formed from the section of the back pressure control portion 5 by extending a portion of the first fuel path 13 toward the top of the figure, which permits the return of fuel to the fuel tank 10. The fuel return line 16 forms a fuel leak path together with a spring chamber 19 (first sliding hole) and the like that will be described subsequently.

The nozzle body 3 has an arbitrary number of fuel injection holes 17 formed at the tip thereof. The injection holes 17 are closed when the tip of the nozzle needle 4 is seated at the seat portion 18 that is linked with the injection holes 17, and the injection holes 17 are opened to thus permit the injection of fuel when the nozzle needle 4 lifts from the seat portion 18.

The spring chamber 19 (first sliding hole) is formed at the center of the injector housing 2 and above the nozzle needle 4, and provided in the spring chamber 19 are a spring seat 20, a nozzle spring 21, which biases the nozzle needle 4 toward the seat portion 18 in the seating direction, and a valve piston 22, which abuts against the spring seat 20 from above.

The back pressure control portion 5 controls the valve piston 22, that is, controls the seating and lifting of the nozzle needle 4 via the spring seat 20 by controlling the back pressure on the nozzle needle 4.

The upper portion of the nozzle needle 4 is capable of sliding in a clearance seal hole 23 (second sliding hole) of the nozzle body 3. The spring chamber 19 communicates with the low-pressure side fuel return line 16 and the nozzle body 3 separates a high-pressure side (fuel reservoir chamber 15) in the clearance seal hole 23 of the nozzle body 3 and the low-pressure side (spring chamber 19).

The injector housing 2 comprises a first seal surface 24 that is at the bottom of the injector housing 2 and lies orthogonal to the longitudinal direction of the injector housing 2. The nozzle body 3 has a second seal surface 25 at the top thereof that lies orthogonal to the longitudinal direction of the nozzle body 3.

The first seal surface 24 and second seal surface 25 ensure a predetermined surface pressure as a result of tightening the nozzle nut 9 using a predetermined seat tightening force. A high pressure seal surface 26 is formed between the first seal surface 24 and second seal surface 25 such that no fuel leaks to outside the fuel injection valve 1 from the first fuel path 13 and the second fuel path 14 through which high pressure fuel passes. The occurrence of a fuel leak causes problems such as that of the invasion of fuel into the engine oil, which produces a reduction in lubricity.

FIG. 14 is a bottom view of the section of the injector housing 2, and illustrates the relative positions of the first fuel path 13 and a pair of first location holes 6.

That is, as shown in the figure, the pair of first location holes 6 are formed in positions that have lateral symmetry with respect to the straight line X joining the center 19C of the spring chamber 19 (injector housing 2) and the center 13C of the first fuel path 13.

In a fuel injection valve 1 having such a constitution, the sealing is generally improved by increasing the tightening force of the nozzle nut 9 at the high pressure seal surface 26 formed by the first seal surface 24 and the second seal surface 25.

However, when the internal pressure of the first fuel path 13 and the second fuel path 14 becomes significantly high, such pressure is difficult to handle by means of a simple increase in the tightening force of the nozzle nut 9, and even if additional improvements are made to the existing material and heat treatment and the like of the injector housing 2 and nozzle body 3, problems arise, namely that the material strength places restrictions on the permissible surface pressure at the high pressure seal surface 26 and there is the danger of a fuel leak.

More particularly, the fuel injection valve 1, which is of a type that has a common rail 12, is different from a conventional jerk-type fuel injection valve and has a different nozzle body. Because a rail pressure is applied from the common rail 12 to the high pressure section of the nozzle body (namely the first fuel path 13, second fuel path 14 and fuel reservoir 15), there is a requirement to increase the seal surface pressure of the high pressure seal surface 26 in line with high pressure injection. Because a fuel leak from this high pressure seal surface 26 involves a fuel leak to outside the fuel injection valve 1, a reliable seal is required.

Documents relating to this kind of fuel injection valve include Japanese Patent Application Laid-Open No. H7-317631, Japanese Patent Application Laid-Open No. H8-165965, and Japanese Patent Application Laid-Open No. H9-242649.

### SUMMARY OF THE INVENTION

The present invention was conceived in view of the aforementioned problems, and has as an object to provide a fuel path sealing structure for a fuel injection valve adapted so as to reliably prevent a fuel leak by increasing the seal surface pressure between a first body such as an injector housing, and a second body such as a nozzle body.

A further object of the present invention is to provide a fuel path sealing structure for a fuel injection valve that permits an increase in the seal surface pressure without a change to the size of the nozzle nut or the corresponding tightening force.

Yet another object of the present invention is to provide a fuel path sealing structure for a fuel injection valve that makes uniform the joining surface of the seal surfaces to thereby stabilize the surface pressure distribution and increase the safety against a fuel leak by means of a reliable target surface pressure.

Yet another object of the present invention is to provide a fuel path sealing structure for a fuel injection valve that permits an increase in the seal performance of the fuel path section without affecting the fuel injection valve or engine performance.

Yet another object of the present invention is to provide a fuel path sealing structure for a fuel injection valve that is capable of preventing a leak of high pressure fuel using simple means without making any substantial changes to a conventional fuel injection valve, more particularly to the injector housing, nozzle body, and the like.

Yet another object of the present invention is to provide a fuel path sealing structure for a fuel injection valve that is capable of preventing a fuel leak by increasing the seal performance between a first body such as an injector housing and a second body such as a nozzle body.

Yet another object of the present invention is to provide a fuel path sealing structure for a fuel injection valve that prevents a fuel leak and permits an increase in stability, using means other than means for increasing the seal surface pressure, that is, even if the seal surface pressure is the same and the fuel pressure is a higher pressure.

That is, the present invention (the first invention) is directed toward the formation over a predetermined surface area, in the seal surface between a first body such as an injector housing and a second body such as a nozzle body, of slightly shallow micro-recesses, in regions other than the high pressure fuel path and the periphery of the seal surface, that is, at the center of the seal surface. The present invention is a fuel path sealing structure for a fuel injection valve, comprising: a first body, which is formed with a first fuel path for high pressure fuel and comprises a first seal surface that surrounds the first fuel path; and a second body, which comprises a second seal surface facing the first seal surface, and which is formed with a second fuel path that communicates with the first fuel path to enable the high pressure fuel to be supplied to injection holes for the high pressure fuel, characterized in that slightly shallow micro-recesses are formed over a predetermined surface area of at least either one of the first seal surface of the first body and the second seal surface of the second body, avoiding the first fuel path, the second fuel path, and the respective periphery of the first body and the second body.

The micro-recesses can be made symmetrical with respect to a straight line that passes through the center of the first and second bodies. The straight line passing through the center of the bodies may be a straight line that follows the radial direction of the bodies or a straight line in the axial direction thereof, and the symmetry may be linear symmetry or rotational symmetry.

The mutual alignment of the first body and the second body can be determined by means of a locating pin that is inserted in location holes, and the micro-recesses can be afforded symmetry by forming, in the seal surfaces, an additional hole which has a diameter that corresponds to that of the location holes.

The shape of the micro-recesses can be afforded symmetry with respect to at least either one of mutually orthogonal straight lines by forming the additional hole on the side opposite the fuel paths.

In the fuel path sealing structure for a fuel injection valve according to the present invention (the first invention), due to the formation over a predetermined surface area, in the seal surface between a first body such as an injector housing and a second body such as a nozzle body, of slightly shallow micro-recesses, in regions other than the high pressure fuel path and the periphery of the seal surface, when the first body and the second body are brought into intimate contact with one another by means of a predetermined tightening torque, the intimate contact area is smaller than that of the prior art, and it is therefore possible to improve the seal performance by increasing the seal surface pressure even when using an equal tightening torque.

If an additional hole that has a diameter equal to that of the location holes is formed and the shape of the micro-recesses can be made symmetrical with respect to mutually orthogonal straight lines, the intimate contact pressure of the joining surface can be made uniform over the whole seal surface whereby increased fuel leak stability is permitted.

The present invention (the second invention) is further directed toward the formation of a fine groove (micro groove) around the high pressure oil paths (fuel paths) in the injector housing and nozzle body, and the like, and toward the secondary sealing of leaking fuel that, upon leaking from the fuel path, subsequently exhibits a pressure drop. The present invention is a fuel path sealing structure for a fuel injection valve, comprising: a first body such as an injector housing, which is formed with a first fuel path for high pressure fuel and comprises a first seal surface that surrounds the first fuel path; and a second body such as a nozzle body, which comprises a second seal surface facing the first seal surface, and which is formed with a second fuel path that communicates with the first fuel path to enable the high pressure fuel to be supplied to injection holes for the high pressure fuel, characterized in that a micro groove is formed in a position around the first fuel path or the second fuel path in at least either one of the first seal surface of the first body and the second seal surface of the second body.

The micro groove can be afforded a closed circular shape.

The micro groove can be afforded an open circular arc shape and can be made able to communicate with a leak path different from the fuel paths.

The micro groove can be made circular and can be made able to communicate with a leak path different from the fuel paths.

In addition to the injector housing and the nozzle body, and the like, the fuel path sealing structure of the present invention can be adopted for parts requiring a reliable sealing of high pressure fuel via a seal surface.

In the fuel path sealing structure for a fuel injection valve according to the present invention (second invention), a fine groove (micro groove) is formed around the fuel path in a first body such as an injector housing and a second body such as a nozzle body. It is therefore possible to provide secondary sealing at the seal surfaces of leaking fuel that, upon leaking on the high pressure side, subsequently exhibits a pressure drop, such that, irrespective of whether there is any kind of increase in the seal surface pressure of the high pressure seal surface section, a fuel leak to the outside from the first fuel path and second fuel path section can be avoided and the reliability of the fuel injection valve can therefore be ensured.

Moreover, on account of the simple constitution, which merely involves the formation of a micro groove in the seal surface of the first body or second body, the invention can be implemented by the straightforward machining of an existing injector housing or nozzle body.

### BRIEF DESCRIPTION OF THE DRAWINGS

FIG. 1 is an enlarged cross-sectional view of the constituent elements of the injector housing 2 section in a fuel path sealing structure 30 for a fuel injection valve according to a first embodiment of the present invention (first invention);

FIG. 2 is similarly a bottom view of the injector housing 2;

FIG. 3 is an enlarged cross-sectional view of the constituent elements, of the injector housing 2 section in a fuel path sealing structure 40 for a fuel injection valve according to a second embodiment of the present invention (first invention);

FIG. 4 is similarly a bottom view of the injector housing 2;

FIG. 5 is similarly a graph showing the area of contact between the injector housing 2 and the nozzle body 3 in the fan-like regions 24A, 24B, 24C and 24D;

FIG. 6 is similarly a graph that shows the flatness upon grinding of the first seal surface 24 of the injector housing 2 and of the second seal surface 25 of the nozzle body 3, and that shows the corresponding machining amount required;

FIG. 7 is an enlarged cross-sectional view of the constituent elements of the injector housing 2 section in a fuel path sealing structure 50 for a fuel injection valve according to the third embodiment of the present invention (second invention);

FIG. 8 is similarly a bottom view of the injector housing 2;

FIG. 9 is similarly a graph showing relationships between positions on the bottom of the injector housing 2 and the corresponding pressures;

FIG. 10 is an enlarged cross-sectional view of the constituent elements of the injector housing 2 section in a fuel path sealing structure 60 for a fuel injection valve according to the fourth embodiment of the present invention (second invention);

FIG. 11 is similarly a bottom view of the injector housing 2;

FIG. 12 is a bottom view of the injector housing 2 in a fuel path sealing structure 70 section for a fuel injection valve according to the fifth embodiment of the present invention (second invention);

FIG. 13 is a cross-sectional view of the constituent elements of a conventional fuel injection valve 1; and

FIG. 14 is similarly a bottom view of the injector housing 2 section.

### DESCRIPTION OF THE PREFERRED EMBODIMENTS

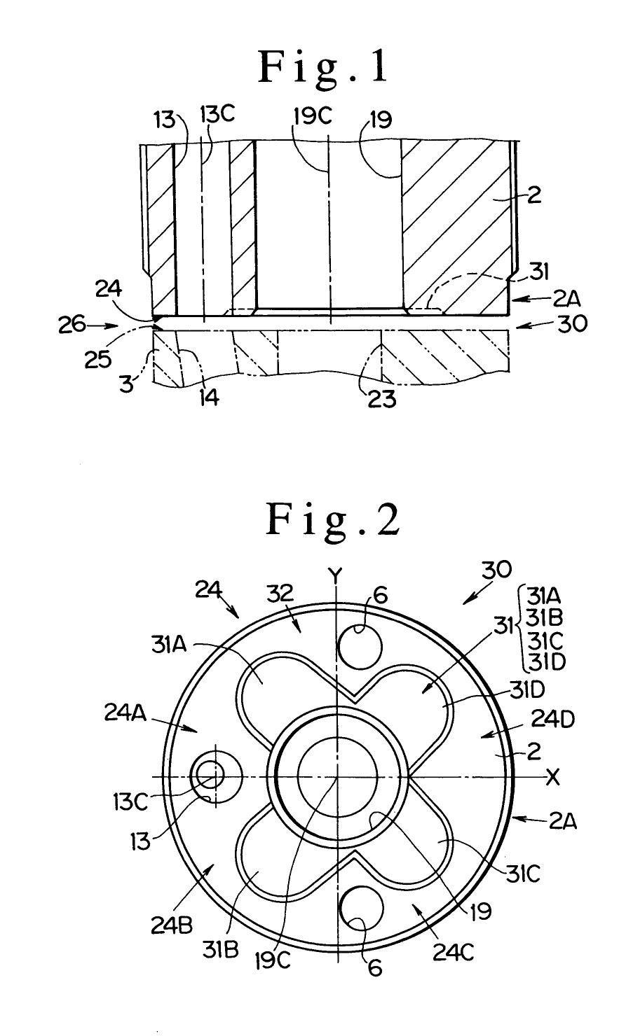

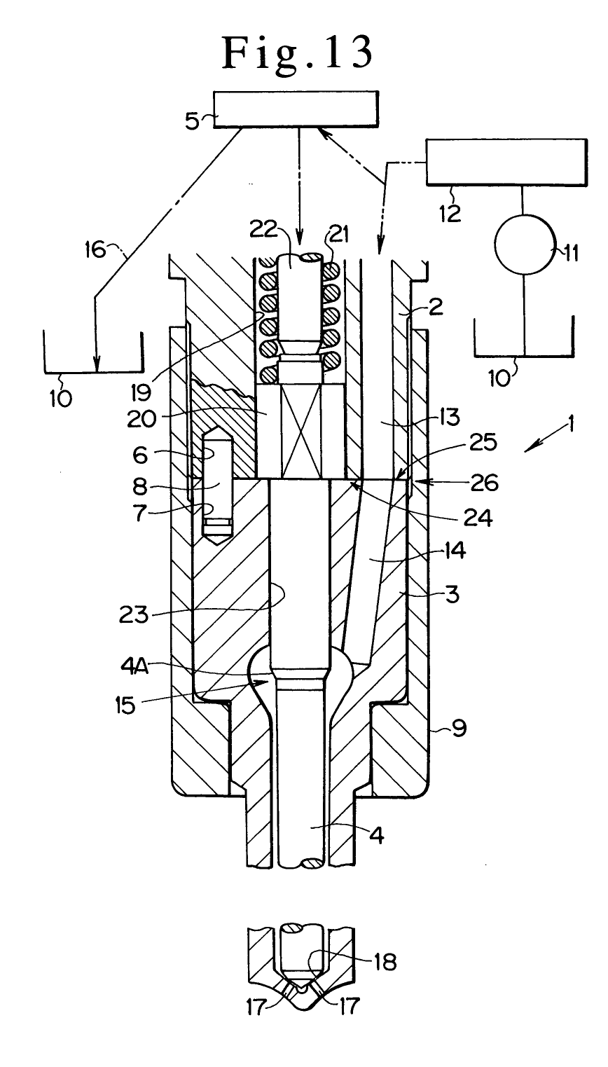

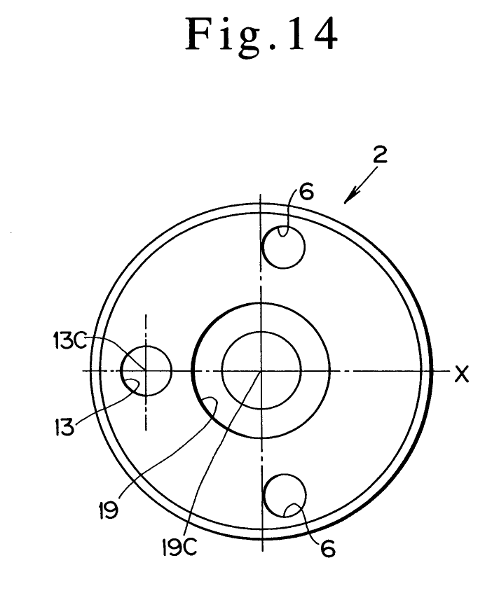

A description will be provided next of the fuel path sealing structure 30 for a fuel injection valve according to the first embodiment of the present invention (first invention), in accordance with FIGS. 1 and 2. However, those parts which are the same as those in FIGS. 13 and 14 have been assigned the same reference numerals, and a detailed description thereof is thus omitted here.

FIG. 1 is an enlarged cross-sectional view of the constituent elements of the injector housing 2 section in a fuel path sealing structure 30 for a fuel injection valve 1. FIG. 2 is similarly a bottom view of the injector housing 2, wherein the fuel path sealing structure 30 has very shallow micro-recesses 31 formed symmetrically in a predetermined shape and area in the bottom of the injector housing 2 (the first seal surface 24), in regions other than the first fuel path 13, the periphery 2A of the injector housing 2 (that is, the periphery of the first seal surface 24 and the second seal surface 25), and a pair of first location holes 6.

In other words, the micro-recesses 31 lie between the periphery 2A of the injector housing 2, and the spring chamber 19 (first sliding hole), and the outermost portion of these recesses does not reach and avoids the first fuel path 13, the pair of first location holes 6 and the periphery 2A of the injector housing 2. The micro-recesses 31 are formed around the spring chamber 19 and so as to be symmetrical with respect to the straight line X that passes through the center 19C of the spring chamber 19 and the center 13C of the first fuel path 13.

Furthermore, the micro-recesses 31 are constituted from the radial recesses 31A, 31B, 31C and 31D which are respectively positioned in fan-like regions 24A, 24B, 24C, and 24D divided into four by a straight line X and a straight line Y that lies orthogonal to straight line X at the center 19C, these radial recesses 31A, 31B, 31C and 31D having substantially the same surface area and facing out ward in a radial shape from the center 19C.

Accordingly, the first seal surface 24 comprises the above-described substantially radial micro-recesses 31, and a pressure contact seal surface 32 which excludes the micro-recesses 31 and which surrounds the micro-recesses 31 in the first seal surface 24, wherein the first fuel path 13 and the pair of first location holes 6 are positioned as openings in the pressure contact seal surface 32.

With regard to the size of the micro-recesses 31, these are very fine recesses whose depth is on the order of 0.013 mm, for example, which constitutes a machining minimum for end milling and the like, these micro-recesses 31 being designed in accordance with the tightening force of the nozzle nut 9 and with the fuel pressure, and so forth.

In the fuel path sealing structure 30 for a fuel injection valve which is thus constituted, the first seal surface 24 of the injector housing 2 and the second seal surface 25 of the nozzle body 3 lie in intimate contact with one another to thereby form a high pressure seal surface 26 as a result of clamping the injector housing 2 and the nozzle body 3 by means of a predetermined axial tightening force imparted by the nozzle nut 9. Of the first seal surface 24 and the second seal surface 25, because only the section constituted by the pressure contact seal surface 32 that has a smaller surface area contacts the second seal surface 25 under pressure, the seal surface pressure is increased beyond that of the prior art, which permits an increase in the seal performance of the first fuel path 13 and second fuel path 14 section even if an equal tightening torque is applied.

In addition, because the micro-recesses 31 are made symmetrical with respect to the straight line X, the balance of the seal surface pressure is made even. It is thus possible to increase the safety against fuel leak, and programmed machining by means of end milling and the like is straightforward. It is thus possible to deal with fuel leaks that accompany the high pressurization of fuel by means of a simple constitution.

The micro-recesses 31 can also be made symmetrical with respect to the straight line Y in addition to the straight line X (line symmetry) and can also be made symmetrical about a straight line that is orthogonal to the straight line X and straight line Y (a straight line that passes through the center 19C of the spring chamber 19, that is, the center of the bodies of the injector housing 2 and the nozzle body 3, and the like) (rotational symmetry).

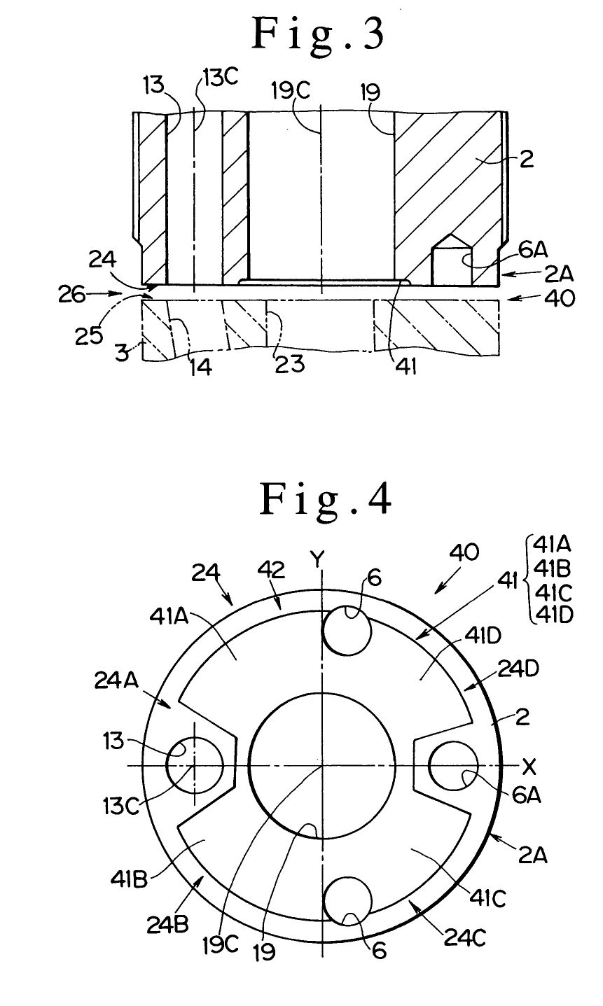

FIG. 3 is an enlarged cross-sectional view of the constituent elements of the injector housing 2 section in a fuel path sealing structure 40 for a fuel injection valve according to the second embodiment of the present invention (first invention). FIG. 4 is similarly a bottom view of the injector housing 2, wherein the fuel path sealing structure 40 has micro-recesses 41 of greater symmetry than that of the fuel path sealing structure 30 (FIG. 2) which are formed in the first seal surface 24 (bottom) of the injector housing 2, and, in addition to the pair of first location holes 6, the fuel path sealing structure 40 is formed with an additional hole 6A that is of the same diameter as the first location holes 6 and is formed on the opposite side of the first fuel path 13.

That is, the micro-recesses 41 are symmetrical with respect to the straight line X, and are constituted from the fan-like recesses 41A, 41B, 41C, and 41D, which have substantially the same surface area, in fan-like regions 24A, 24B, 24C, and 24D.

The additional hole 6A lies on the straight line X on the opposite side to the first fuel path 13 and is located at a midway point between the other pair of first location holes 6.

Further, the location and size of the additional hole 6A are determined in accordance with the location, shape, and size of the micro-recesses 41, and the corresponding fan-like recesses 41A, 41B, 41C, and 41D, and the shape of the micro-recesses 41 may be symmetrical with respect to both the straight line X and the straight line Y, and can preferably be of an arbitrary design so long as the micro-recesses 41 have a uniform surface area in the fan-like regions 24A, 24B, 24C, and 24D.

Naturally, like the micro-recesses 31, the micro-recesses 41 can also be made symmetrical with respect to the straight line Y in addition to the straight line X (line symmetry) and can also be made symmetrical about a straight line that is orthogonal to the straight line X and straight line Y (a straight line that passes through the center 19C of the spring chamber 19, that is, the center of the bodies of the injector housing 2 and the nozzle body 3, and the like) (rotational symmetry).

Therefore, the first seal surface 24 is constituted from the above-described substantially circular or hourglass-shaped micro-recesses 41, and a pressure contact seal surface 42 which excludes the micro-recesses 41 and surrounds the micro-recesses 41 in the first seal surface 24, wherein the first fuel path 13 and the additional hole 6A are located in the pressure contact seal surface 42 and the other pair of first location holes 6 are located in the micro-recesses 41.

Like the fuel path sealing structure 30 shown in FIGS. 1 and 2, in the fuel path sealing structure 40 for a fuel injection valve thus constituted, the first seal surface 24 of the injector housing 2 and the second seal surface 25 of the nozzle body 3 lie in intimate contact with one another to thereby form a high pressure seal surface 26 as a result of clamping the injector housing 2 and the nozzle body 3 by means of a predetermined axial tightening force imparted by the nozzle nut 9. Of the first seal surface 24 and the second seal surface 25, because only the section constituted by the pressure contact seal surface 42 that has a smaller surface area contacts the second seal surface 25 under pressure, the seal surface pressure is increased beyond that of the prior art, which permits an increase in the seal performance of the first fuel path 13 and second fuel path 14 section even if an equal tightening torque is applied.

Furthermore, because the micro-recesses 41 are made symmetrical with respect to the straight line X, and micro-recesses 41 form a nearly symmetrical shape also with respect to the straight line Y, the balance of the seal surface pressure at the first seal surface 24 is made even more even, thus permitting an increase in the safety against fuel leak, and programmed machining by means of end milling and the like is straightforward. It is thus possible to deal with fuel leaks that accompany the high pressurization of fuel by means of a simple constitution.

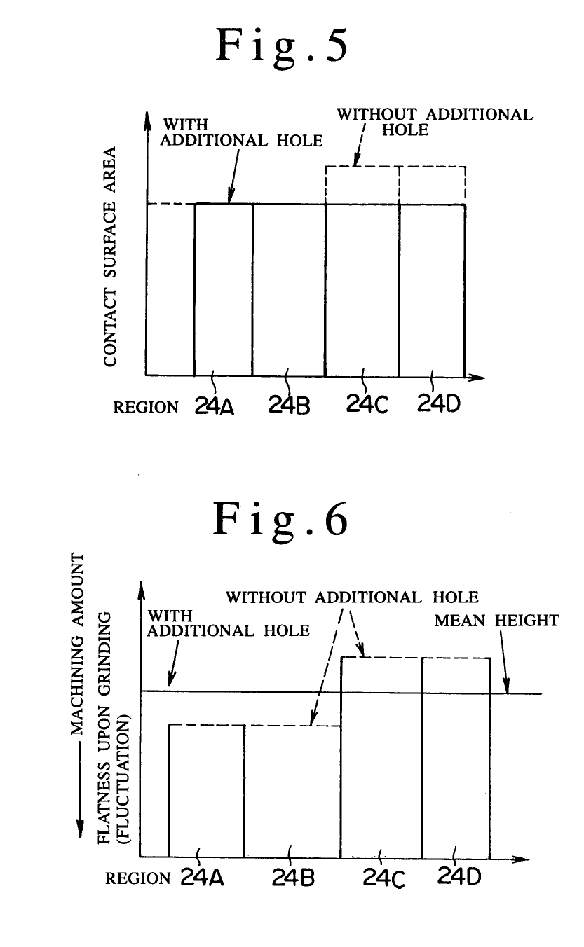

FIG. 5 is a graph showing the area of contact between the injector housing 2 and the nozzle body 3 in the fan-like regions 24A, 24B, 24C and 24D. FIG. 6 is similarly a graph that shows the flatness upon grinding of the first seal surface 24 of the injector housing 2 and of the second seal surface 25 of the nozzle body 3, and that shows the corresponding amount of machining required.

As shown in FIG. 5, when there is no additional hole 6A (dotted line), the area of contact of the fan-like regions 24C and 24D is greater than that of the fan-like regions 24A and 24B in comparison with a case where the additional hole 6A is present (solid line).

The formation of the additional hole 6A thus makes it possible to obtain a more uniform seal surface pressure.

Also, as shown in FIG. 6, in comparison with a case where the additional hole 6A is present (solid line), in the absence of the additional hole 6A (dotted line), it is necessary to reduce the contact area by making the flatness upon grinding of the fan-like regions 24A and 24B lower than that of the fan-like regions 24C and 24D. However, when the additional hole 6A is present (solid line), the machining amount of the seal surfaces 24 and 25 is made uniform and the mean height can be made substantially uniform.

The formation of the additional hole 6A thus makes it possible to make the machining process more uniform.

The above-described micro-recesses 31 (FIG. 2) and the micro-recesses 41 (FIG. 4) according to the present invention can also be formed in the upper face of the nozzle body 3 (second seal surface 25).

In addition, the micro-recesses 31 and micro-recesses 41 can be adopted not only for a product comprising a body that connects to a fuel injection nozzle such as the nozzle body 3, but also for a part that connects interlinking high pressure fuel paths such as the first fuel path 13 and the second fuel path 14 to each other, and for a component made of a general material and subjected to general heat treatment in order to provide sealing for high pressure fuel.

According to the present invention described above (the first invention), due to the formation of the micro-recesses which serve to avoid mutual contact at the center at the seal surfaces of the injector housing or the nozzle body, the seal surface pressure can be increased to thus permit greater fuel leak stability.

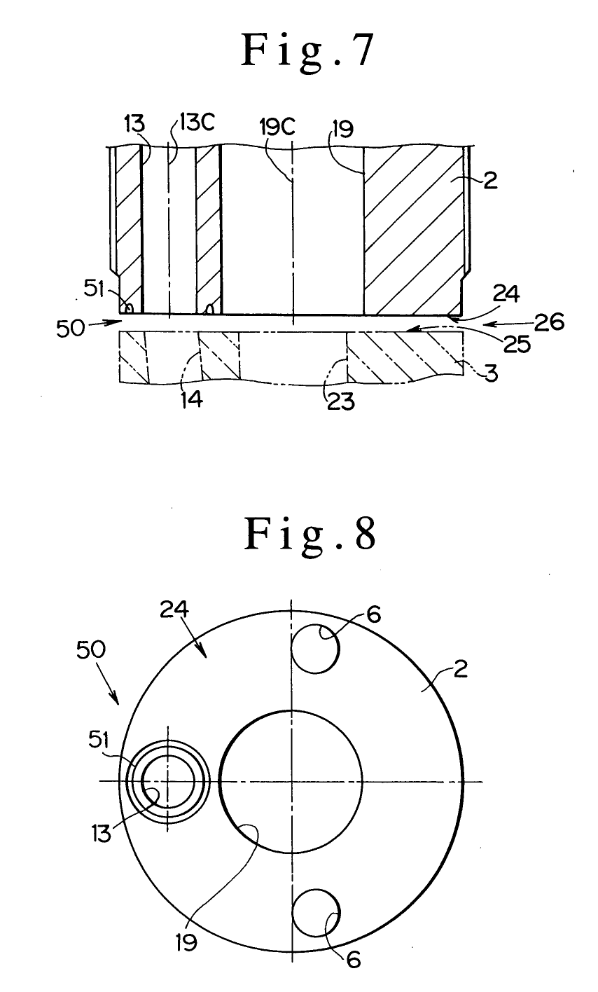

A description will be provided next, in accordance with FIGS. 7 through 9, of a fuel path sealing structure 50 for a fuel injection valve according to the third embodiment of the present invention (second invention).

FIG. 7 is an enlarged cross-sectional view of the constituent elements of the injector housing 2 section in a fuel path sealing structure 50 for the fuel injection valve 1. FIG. 8 is similarly a bottom view of the injector housing 2, wherein the fuel path sealing structure 50 is formed, for example, with a closed circular micro groove 51 that is positioned around the first fuel path 13 in the bottom (first seal surface 24) of the injector housing 2 so that this micro groove 51 surrounds the first fuel path 13.

The micro groove 51 is formed between the peripheral face of the injector housing 2, and the spring chamber 19 (first sliding hole), and the outermost portion of the micro groove 51 is located at a midway point between the peripheral face of the injector housing 2, and the first fuel path 13. The micro groove 51 is formed so as to ensure an equal interval from the first fuel path 13, that is, the circumferential position of the micro groove 51 is established such that the micro groove 51 is concentric with the first fuel path 13, such that the pressure of the high pressure fuel in the first fuel path 13 acts uniformly on the micro groove 51.

With regard to the size of the micro groove 51, this is a very fine groove whose depth and width are on the order of 0.013 mm, for example, which constitutes a machining minimum for end milling and the like, the micro groove 51 being designed in accordance with the tightening force of the nozzle nut 9 and with the fuel pressure, and the like.

In the fuel path sealing structure 50 for a fuel injection valve which is thus constituted, a leak of high pressure fuel from the first fuel path 13 and second fuel path 14 can be more reliably prevented.

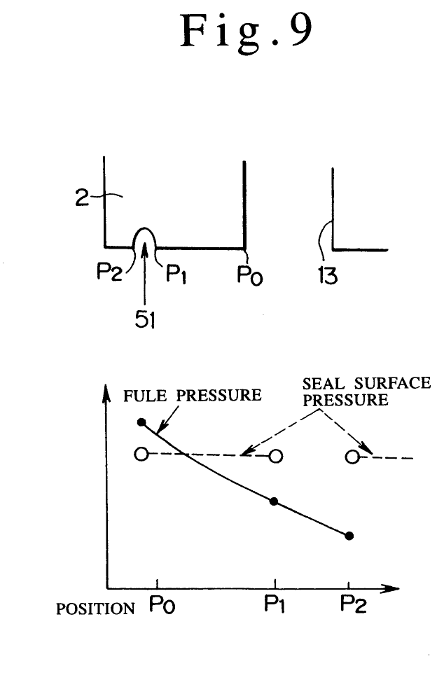

That is, FIG. 9 is a graph showing relationships between positions on the bottom of the injector housing 2 and the corresponding pressures. Even in the event that the fuel pressure (solid line) is larger than the seal surface pressure (dotted line) at the position P0 on the circumference of the first fuel path 13 and there occurs a fuel leak in the peripheral direction of the first fuel path 13, due to the drop in pressure of leaking fuel at the position P1 on the inner circumference of the micro groove 51, the seal surface pressure is then greater than the fuel pressure and secondary sealing is thus made possible by ensuring that the seal surface pressure at the position P2 on the outer circumference of the micro groove 51 is greater than the fuel pressure. A fuel leak in the peripheral direction of the injector housing 2 and outside the fuel injection valve 1 can thus be prevented.

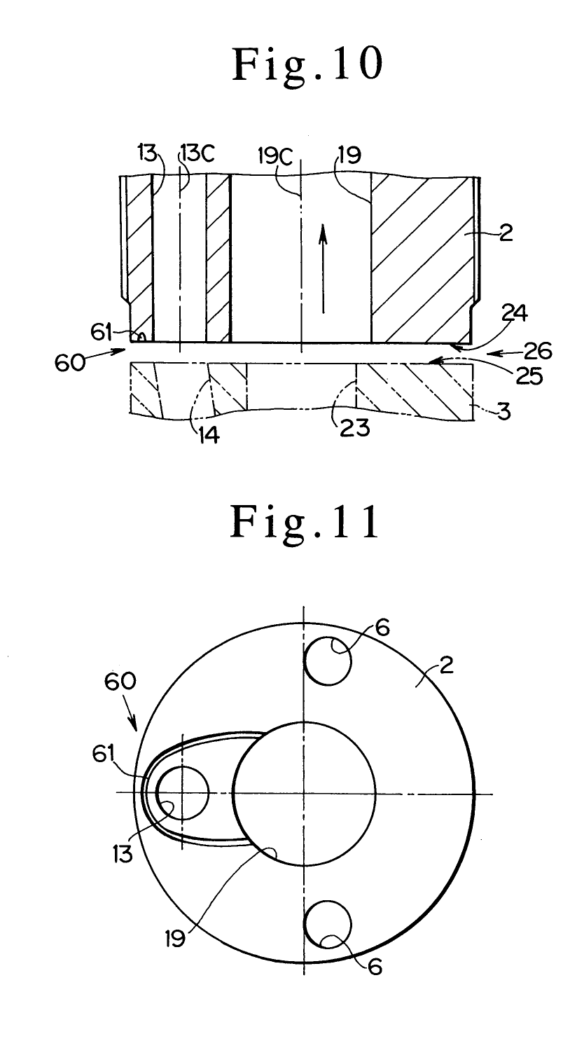

FIG. 10 is an enlarged cross-sectional view of the constituent elements of the injector housing 2 section in a fuel path sealing structure 60 for a fuel injection valve according to the fourth embodiment of the present invention (second invention). FIG. 11 is similarly a bottom view of the injector housing 2, wherein the fuel path sealing structure 60 is formed, for example, with an open circular arc shaped micro groove 61 that is positioned around the first fuel path 13 in the bottom (first seal surface 24) of the injector housing 2 so that this groove 61 surrounds the first fuel path 13. Both ends of the micro groove 61 are able to communicate with the low-pressure side spring chamber 19 (first sliding hole).

The shape of the arc of the micro groove 61 is optional, and more particularly the outermost portion of the micro groove 61 is located at a midway point between the peripheral face of the injector housing 2, and the first fuel path 13, such that the micro groove 61 is formed so as to be symmetrical with respect to the radial direction of the injector housing 2.

Like the micro groove 51 (FIG. 7 and FIG. 8), the dimensions of the micro groove 61 are set at a depth and width that pertain to the machining minimum, for example.

In a fuel path sealing structure 60 for a fuel injection valve which is thus constituted, the fuel which leaks out from the first fuel path 13 to the micro groove 61 can also be returned to the fuel tank 10 via the spring chamber 19, which is a low-pressure side leak path, and via the fuel return line 16.

It is thus possible to prevent fuel from leaking outside the fuel injection valve 1, that is, outside the engine, by returning leaking fuel to the fuel return line 16, which makes it possible to prevent an offensive odor and a fire, and the like. The amount of fuel that leaks out to the fuel return line 16 is extremely small and does not affect the product performance.

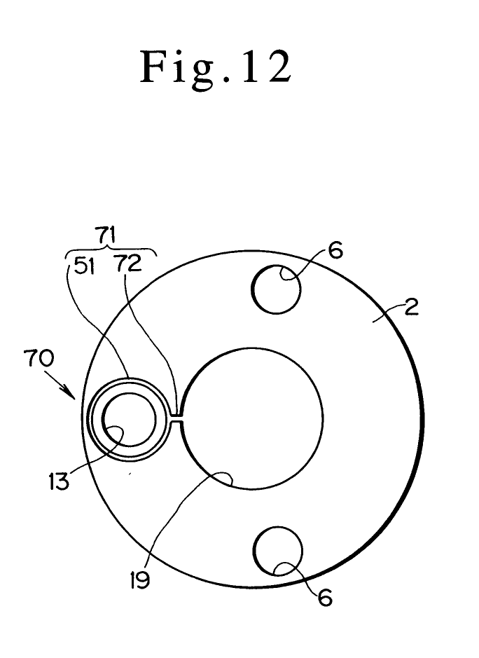

FIG. 12 is a bottom view of the injector housing 2 in a fuel path sealing structure 70 section for a fuel injection valve according to the fifth embodiment of the present invention (second invention), wherein the fuel path sealing structure 70 is, for example, formed with a micro groove 71 in the bottom (first seal surface 24) of the injector housing 2.

This micro groove 71 is constituted from the micro groove 51, which has the same circular shape as that in the fuel path sealing structure 50, and a linking groove 72, which links the micro groove 51 to the spring chamber 19 (leak path).

In the fuel path sealing structure 70 for a fuel injection valve thus constituted, the micro groove 71 works similarly to the micro groove 51 shown in FIGS. 8 and 9 and is capable of discharging leaking fuel to the spring chamber 19 via the linking groove 72.

The micro groove 51 (FIG. 8), 61 (FIG. 10), and 71 (FIG. 12) according to the present invention as described above can also be formed in the upper face (the second seal surface 25) of the nozzle body 3.

In addition, this micro groove 51, 61, 71 can be adopted not only for a product comprising a body that connects to a fuel injection nozzle such as the nozzle body 3, but also for a part that connects interlinking high pressure fuel paths such as the first fuel path 13 and the second fuel path 14 to each other, and for a component made of a general material and subjected to general heat treatment in order to provide sealing for high pressure fuel.

According to the present invention above (the second invention), the formation of a micro groove in the seal surface makes secondary sealing possible by causing a stepwise reduction in the fuel pressure, which makes it possible to more reliably prevent a high pressure fuel leak and to improve safety even using an equal seal surface pressure.

1. A fuel path sealing structure for a fuel injection valve, comprising:
a first body, having a periphery and including a first fuel path therein for high pressure fuel, the body comprises a first seal surface the first fuel path passes through the first seal surface and the first seal surface surrounds the first fuel path; and
a second body having a periphery and including a second seal surface facing the first seal surface, the second body comprises a second fuel path therein, the second fuel path passes through the second seal surface, and the second seal surface surrounds the second fuel path:
the first fuel path and the second fuel path pass through the first and second seal surfaces respectively at locations such that the second fuel path communicates with the first fuel path to enable the high pressure fuel to be supplied to injection holes for the high pressure fuel,
wherein slightly shallow micro-recesses are formed over a predetermined surface area of at least one of the first seal surface of the first body and the second seal surface of the second body, avoiding the first fuel path, avoiding the second fuel path, and avoiding the respective peripheries of the first body and the second body.

2. The fuel path sealing structure for a fuel injection valve according to claim 1, wherein the micro-recesses are symmetrical with respect to a straight line that passes through respective centers of the first and second bodies.

3. The fuel path sealing structure for a fuel injection valve according to claim 1, further comprising location holes in the first and second bodies and passing through the first and second seal surfaces, the location holes being aligned, the first body and the second body are mutually aligned, a locating pin inserted in the respective location holes in the first and second seal surfaces for mutually aligning the first and second bodies, and the micro-recesses are afforded symmetry by forming an additional hole in the seal surfaces, the additional hole having a diameter that corresponds to a diameter of the location holes.

4. The fuel path sealing structure for a fuel injection valve according to claim 3, wherein the micro-recesses are shaped to afford symmetry with respect to at least either one of mutually orthogonal straight lines by forming the additional hole on the side opposite the fuel paths.

5. A fuel path sealing structure for a fuel injection valve, comprising:
a first body, having a periphery and including a first fuel path therein for high pressure fuel, the body comprises a first seal surface, the first fuel path passes through the first seal surface, and the first seal surface surrounds the first fuel path; and
a second body having a periphery and including a second seal surface facing the first seal surface, the second body comprises a second fuel path therein, the second fuel path passes through the second seal surface and the second seal surface surrounds the second fuel path:
the first fuel path and the second fuel path pass through the first and second seal surfaces respectively at locations such that the second fuel path communicates with the first fuel path to enable the high pressure fuel to be supplied to injection holes for the high pressure fuel,
further comprising a micro groove formed in a position around the first fuel path or the second fuel path in at least one of the first seal surface of the first body and the second seal surface of the second body.

6. The fuel path sealing structure for a fuel injection valve according to claim 5, wherein the micro groove has a closed circular shape.

7. The fuel path sealing structure for a fuel injection valve according to claim 5, wherein the micro groove has an open circular arc shape and is able to communicate with a leak path that is different from the fuel paths.

8. The fuel path sealing structure for a fuel injection valve according to claim 5, wherein the micro groove is circular in shape and is able to communicate with a leak path different from the fuel paths.

9. A fuel injection valve provided with a fuel path sealing structure, comprising:
a first body having a periphery and including a first fuel path therein for high pressure fuel, the body comprises a first seal surface, the first fuel path passes through the first seal surface, and the first seal surface surrounds the first fuel path; and
a second body having a periphery and including a second seal surface facing the first seal surface, the second body comprises a second fuel path therein, the second fuel path passes through the second seal surface, and the second seal surface surrounds the second fuel path;
the first fuel path and the second fuel path pass through the first and second seal surfaces respectively at locations such that the second fuel path communicates with the first fuel path to enable the high pressure fuel to be supplied to injection holes for the high pressure fuel,
wherein slightly shallow micro-recesses are formed over a predetermined surface area of at least one of the first seal surface of the first body and the second seal surface of the second body, avoiding the first fuel path, avoiding the second fuel path, and avoiding the respective peripheries of the first body and the second body.

10. A fuel injection valve provided with a fuel path sealing structure according to claim 9, wherein the micro-recesses are symmetrical with respect to a straight line that passes through respective centers of the first and second bodies.

11. A fuel injection valve provided with a fuel path sealing structure according to claim 9, further comprising location holes in the first and second bodies and passing through the first and second seal surfaces, the location holes being aligned, the first body and the second body are mutually aligned, a locating pin inserted in the respective location holes in the first and second seal surfaces for mutually aligning the first and second bodies, and the micro-recesses are afforded symmetry by forming an additional hole in the seal surfaces, the additional hole having a diameter that corresponds to a diameter of the location holes.

12. A fuel injection valve provided with a fuel path sealing structure according to claim 11, wherein the micro-recesses are shaped to afford symmetry with respect to at least either one of mutually orthogonal straight lines by forming the additional hole on the side opposite the fuel paths.

13. A fuel injection valve provided with a fuel path sealing structure, comprising:
a first body having a periphery and including a first fuel path therein for high pressure fuel, the body comprises a first seal surface, the first fuel path passes through the first seal surface, and the first seal surface surrounds the first fuel path; and
a second body having a periphery and including a second seal surface facing the first seal surface, the second body comprises a second fuel path therein, the second fuel path passes through the second seal surface, and the second seal surface surrounds the second fuel path;
the first fuel path and the second fuel path pass through the first and second seal surfaces respectively at locations such that the second fuel path communicates with the first fuel path to enable the high pressure fuel to be supplied to injection holes for the high pressure fuel,
further comprising a micro groove formed in a position around the first fuel path or the second fuel path in at least one of the first seal surface of the first body and the second seal surface of the second body.

14. A fuel injection valve provided with a fuel path sealing structure according to claim 13, wherein the micro groove has a closed circular shape.

15. A fuel injection valve provided with a fuel path sealing structure according to claim 13, wherein the micro groove has an open circular arc shape and is able to communicate with a leak path that is different from the fuel paths.

16. A fuel injection valve provided with a fuel path sealing structure according to claim 13, wherein the micro groove is circular in shape and is able to communicate with a leak path different from the fuel paths.
